(19) United States
(12) Patent Application Publication
(10) Pub. No.: US 2024/0079732 A1
(43) Pub. Date: Mar. 7, 2024

(54) METHOD OF ASSEMBLING TRACTION BATTERY PACK AND TRACTION BATTERY PACK ASSEMBLY

(71) Applicant: Ford Global Technologies, LLC, Dearborn, MI (US)

(72) Inventors: Marc Dugas, Wixom, MI (US); Patrick Daniel Maguire, Ann Arbor, MI (US)

(21) Appl. No.: 18/185,572

(22) Filed: Mar. 17, 2023

Related U.S. Application Data
(60) Provisional application No. 63/403,445, filed on Sep. 2, 2022.

(51) Int. Cl. H01M 50/516; H01M 10/0525; H01M 50/211; H01M 50/51

(52) U.S. Cl. CPC H01M 50/516; H01M 10/0525; H01M 50/211; H01M 50/51; H01M 2220/20

(57) ABSTRACT

A method of assembling a battery pack, includes positioning at least one first battery cell having tab terminals adjacent to at least one second battery cell having tab terminals to provide a battery cell subassembly. The tab terminals of the at least one first battery cell and the at least one second battery cell are connected on a first side of the battery cell subassembly. The tab terminals of the at least one first battery cell and the at least one second battery cell are disconnected on an opposite, second side of the battery cell subassembly. After he positioning, the method includes inserting the tab terminals that are disconnected through at least one aperture in a cross-member.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to assembling a traction battery pack and, more particularly, to connecting battery cells of a traction battery pack.

### BACKGROUND

A traction battery pack of an electrified vehicle can include groups of battery cells arranged in one or more cell stacks. At least some of the battery cells can be electrically connected together.

### SUMMARY

In some aspects, the techniques described herein relate to a method of assembling a battery pack, including: positioning at least one first battery cell having tab terminals adjacent to at least one second battery cell having tab terminals to provide a battery cell subassembly, the tab terminals of the at least one first battery cell and the at least one second battery cell connected on a first side of the battery cell subassembly, the tab terminals of the at least one first battery cell and the at least one second battery cell disconnected on an opposite, second side of the battery cell subassembly; and after the positioning, inserting the tab terminals that are disconnected through at least one aperture in a cross-member.

In some aspects, the techniques described herein relate to a method, further including, after the inserting, connecting the tab terminals inserted through the at least one aperture to at least one tab terminal of at least one other battery cell subassembly.

In some aspects, the techniques described herein relate to a method, further including, prior to the positioning, connecting at least one tab terminal of the at least one first battery cell to at least one tab terminal the at least one second battery cell.

In some aspects, the techniques described herein relate to a method, further including positioning by folding the at least one first battery cell over the at least one second battery cell.

In some aspects, the techniques described herein relate to a method, wherein the tab terminals connected on the first side are electrically connected to each other.

In some aspects, the techniques described herein relate to a method, wherein the tab terminals connected on the first side are welded to each other.

In some aspects, the techniques described herein relate to a method, wherein the cross-member is a first cross-member, and further including covering the tab terminals that are connected with a second cross-member without inserting the tab terminals that are connected through an aperture in the second cross-member.

In some aspects, the techniques described herein relate to a method, wherein the tab terminals that are connected are sandwiched between the second cross-member and cases of the at least one first battery cell and the at least one second battery cell.

In some aspects, the techniques described herein relate to a method, wherein the battery cell subassembly includes two first battery cells and two second battery cells.

In some aspects, the techniques described herein relate to a method, wherein the battery cell subassembly is below 60 Volts.

In some aspects, the techniques described herein relate to a method, wherein the at least one first battery cell and the at least one second battery cell are battery cells of a traction battery pack.

In some aspects, the techniques described herein relate to a method, wherein the at least one first battery cell and the at least one second battery cell are lithium-ion pouch cells.

In some aspects, the techniques described herein relate to a battery pack assembly, including: at least one first battery cell each having first tab terminals extending from opposing sides of a first case; at least one second battery cell each having a second tab terminals extending from opposing sides of a second case, the at least one first and second battery cells positioned adjacent to each other to provide a battery cell subassembly, the first and second tab terminals of the at least one first battery cell and the at least one second battery cell connected on a first side of the battery cell subassembly, the first and second tab terminals of the at least one first battery cell and the at least one second battery cell disconnected on an opposite, second side of the battery cell subassembly; and a cross-member having at least one aperture, the first and second tab terminals that are disconnected inserted through the aperture.

In some aspects, the techniques described herein relate to a battery pack assembly, wherein the cross-member is a first cross-member, and further including a second cross-member, the first and second tab terminals that are connected on the first side are sandwiched between the second cross-member and cases of the at least one first battery cell and the at least one second battery cell.

In some aspects, the techniques described herein relate to a battery pack assembly, wherein the first and second battery cells are lithium-ion pouch cells.

In some aspects, the techniques described herein relate to a battery pack assembly, wherein the first and second tab terminals that are connected on the first side are directly joined to each other with at least one weld.

In some aspects, the techniques described herein relate to a battery pack assembly, wherein the first and second battery cells are constituents of a traction battery pack.

In some aspects, the techniques described herein relate to a battery pack assembly, wherein at least one first battery cell and the at least one second battery cell of the battery cell subassembly are connected in series to each other.

In some aspects, the techniques described herein relate to a battery pack assembly, wherein a voltage of the battery cell subassembly is below 60 Volts. The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1 according to an exemplary embodiment of the present disclosure.

FIG. 3 illustrates a perspective view of a battery cell from the battery pack of FIG. 2.

FIGS. 4A-4C illustrate selected stages in a method of providing a battery cell subassembly according to an exemplary aspect of the present disclosure.

FIG. 5 illustrates a perspective view of selected portions of the battery pack of FIG. 2 when assembling a cell stack of the battery pack.

FIG. 6 illustrates a section view taken through a cell stack area of the battery pack of FIG. 2.

FIG. 7 illustrates a close-up view of terminals of the cell stack.

### DETAILED DESCRIPTION

This disclosure details exemplary methods of assembling a traction battery pack and, in particular, methods of electrically connecting tab terminals of the traction battery pack. The disclosure additionally details exemplary battery packs that are assembled using these methods.

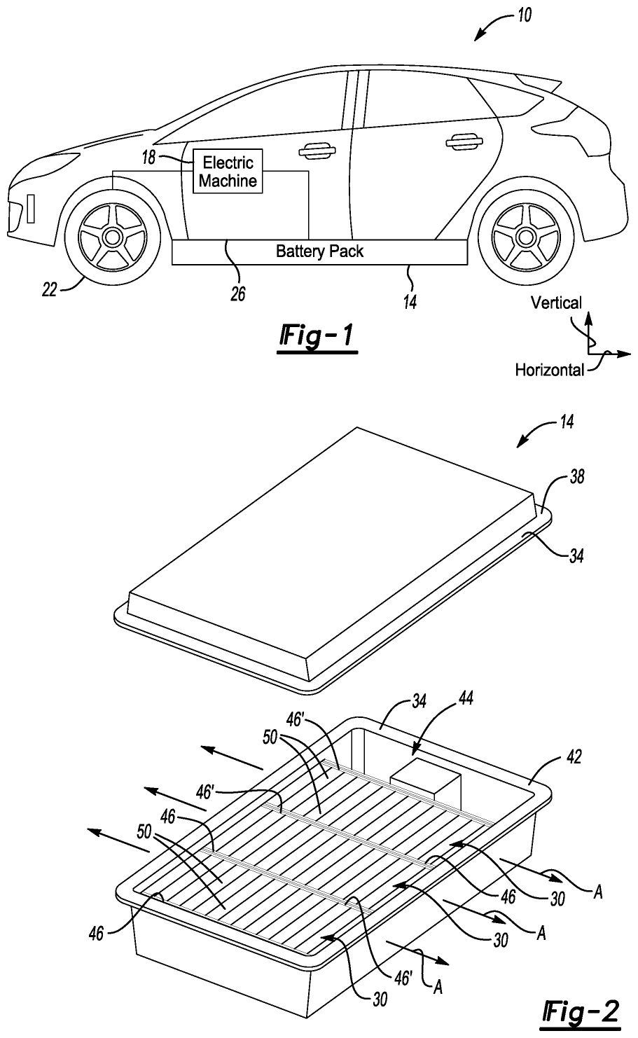

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

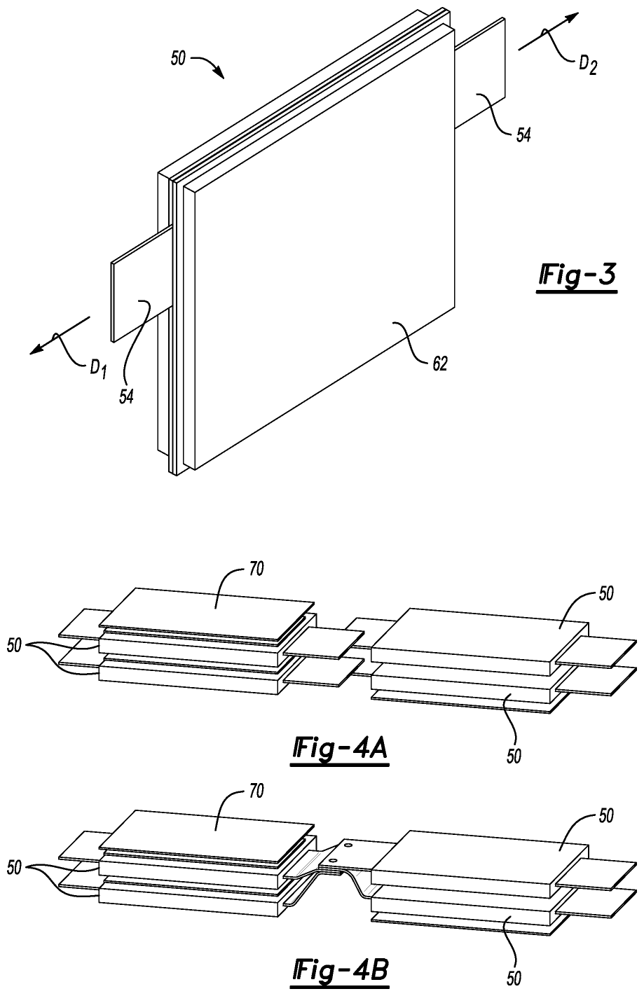

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example. Cross-members 46 are positioned between the cell stacks 30 within the interior area 44.

Each of the cell stacks 30 includes, among other things, a plurality of battery cells 50 (or simply “cells”) distributed along a respective cell stack axis A. In this example, the axes of the cell stacks 30 and the cross-members 46 are parallel to each other and extend longitudinally in a cross-vehicle direction.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

The exemplary battery cells 50 each include a pair of tab terminals 54 extending from opposing sides of a battery cell case 62. A multi-layered film can provide the case 62, for example. The tab terminals 54 can have opposite polarities (i.e., one positive and one negative). The tab terminals 54 can be a metal, such as copper or aluminum.

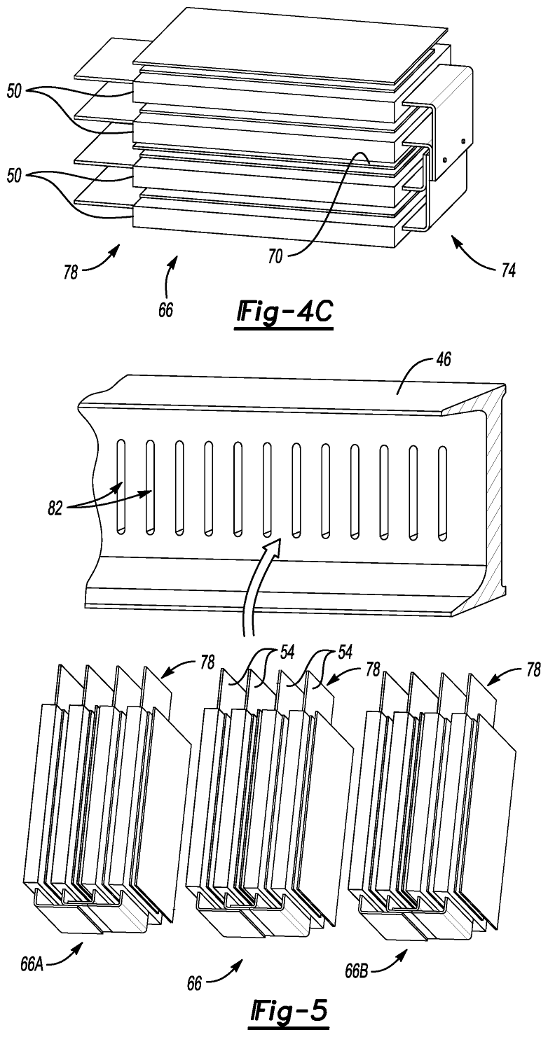

With reference now to FIGS. 4A-4C and continued reference to FIGS. 2-3, the cell stacks 30 are provided by a plurality of battery cell subassemblies 66. In this example, the battery cell subassemblies 66 each include four individual battery cells 50.

The battery cell subassemblies 66 are provided by connecting together some of the tab terminals 54 of the four battery cells 50. In this example, to provide the battery cell subassemblies 66, two battery cells 50 are stacked and placed adjacent two other stacked battery cells 50 as shown in FIG. 4A. An insulative layer 70 can be placed on one of the stacks of two battery cells.

Next, selected terminals 54 of the battery cells 50 are directly joined to each other as shown in FIG. 4B. Welds can be used to join the terminals 54. When directly joined, the terminals 54 are electrically connected. Directly joining the terminals 54 electrically connects the battery cells 50 in series.

As shown in FIG. 4C, the battery cells 50 in one of the stacks are then repositioned by folding those cells about the terminals 54 that are joined to each other. The battery cells 50 are folded like a book until all four battery cells 50 are stacked together and sandwiching the insulative layer 70.

Thus, the battery cell subassembly 66, prior to installation within the battery pack 14, includes tab terminals 54 that are connected on a first side 74 of the battery cell subassembly 66 and disconnected on an opposite, second side 78 of the battery cell subassembly 66.

The battery cells 50 are each about 4.3 Volts in this example. The battery cell subassemblies 66, with the tab terminals 54 connected on the first side 74, are about 8.6 Volts. The battery cell subassemblies 66 are considered low voltage (i.e., below 60 Volts). A low voltage assembly may be more convenient to ship and then transport within a manufacturing facility than a high voltage assembly.

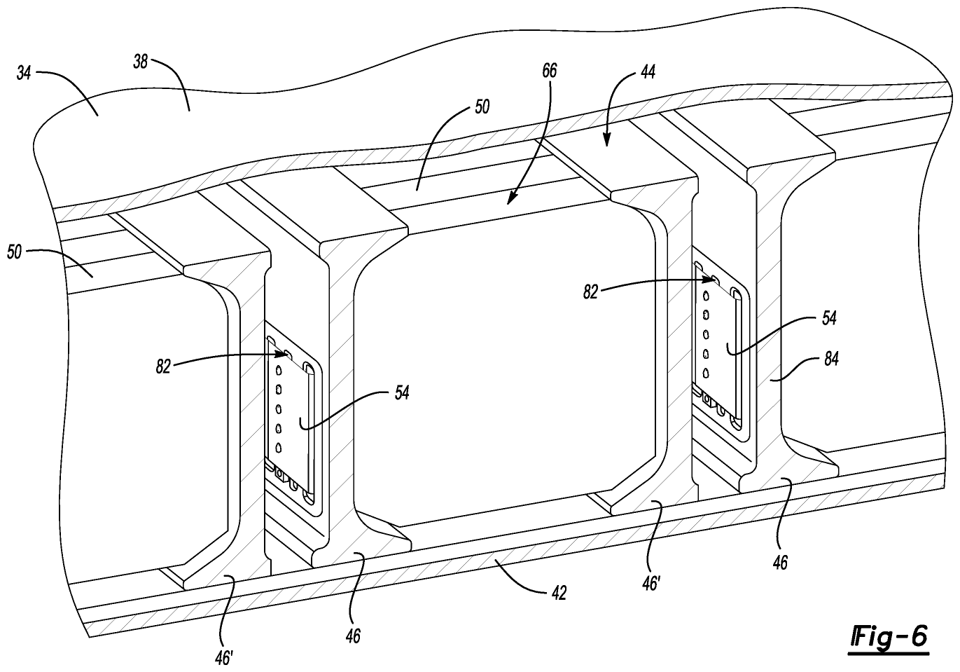

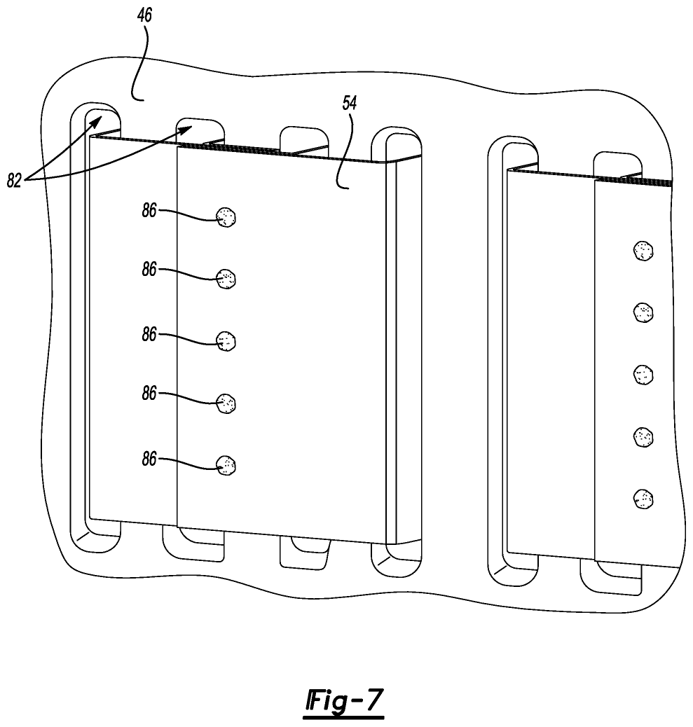

With reference to FIGS. 5-7, after loading the battery cell subassemblies 66 into the enclosure tray 42, the battery cell subassemblies 66 can be electrically connected to other battery cell subassemblies 66 to provide the cell stacks 30. The cell stacks 30, which are high voltage, are thus established when loaded within at least a portion of the enclosure assembly 34. Moving high-voltage cell stacks around an assembly plant outside of an enclosure assembly is thus not required.

To assemble one of the cell stacks 30, the battery cell subassembly 66 are repositioned into the enclosure tray 42. The battery cell subassembly 66 is repositioned such that the tab terminals 54 that are disconnected on the second side 78 are inserted through apertures 82 in one of the cross-members 46. The battery cell subassembly 66 is positioned along the axis of the cell stack 30 next to other battery cell subassemblies 66A and 66B, which have their disconnected tab terminals 54 inserted through respective apertures 82 in the same cross-member 46. Other battery cell subassemblies are similarly positioned along the axis of the cell stack 30 until the cell stack 30 reaches its desired size.

The tab terminals 54 that extend through the apertures 82 in one of the cross-members 46 are then joined to other tab terminals 54 that extend through apertures 82 in the one of the cross-members 46. The tab terminals 54 can be joined using welds 86, for example. The joining of the terminals 54 extending through the apertures 82 can electrically connect the battery cell subassembly 66 to the other battery cell subassemblies 66A and 66V, which establishes a high voltage arrangement of cells 50, but within the enclosure tray 42.

When repositioned into the enclosure tray 42, the first side 74 of the battery cell subassembly 66 is positioned next to one of the cross-members 46′, which does not include apertures that receive a terminal tab. The cross-members 46′ cover the tab terminals 54 of the battery cell subassembly 66 that are connected. not tab terminals extend through the cross-members 46′ in this example.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling a battery pack, comprising:
positioning at least one first battery cell having tab terminals adjacent to at least one second battery cell having tab terminals to provide a battery cell subassembly, the tab terminals of the at least one first battery cell and the at least one second battery cell connected on a first side of the battery cell subassembly, the tab terminals of the at least one first battery cell and the at least one second battery cell disconnected on an opposite, second side of the battery cell subassembly; and
after the positioning, inserting the tab terminals that are disconnected through at least one aperture in a cross-member.

2. The method of claim 1, further comprising, after the inserting, connecting the tab terminals inserted through the at least one aperture to at least one tab terminal of at least one other battery cell subassembly.

3. The method of claim 1, further comprising, prior to the positioning, connecting at least one tab terminal of the at least one first battery cell to at least one tab terminal the at least one second battery cell.

4. The method of claim 3, further comprising positioning by folding the at least one first battery cell over the at least one second battery cell.

5. The method of claim 1, wherein the tab terminals connected on the first side are electrically connected to each other.

6. The method of claim 1, wherein the tab terminals connected on the first side are welded to each other.

7. The method of claim 1, wherein the cross-member is a first cross-member, and further comprising covering the tab terminals that are connected with a second cross-member without inserting the tab terminals that are connected through an aperture in the second cross-member.

8. The method of claim 7, wherein the tab terminals that are connected are sandwiched between the second cross-member and cases of the at least one first battery cell and the at least one second battery cell.

9. The method of claim 1, wherein the battery cell subassembly includes two first battery cells and two second battery cells.

10. The method of claim 1, wherein the battery cell subassembly is below 60 Volts.

11. The method of claim 1, wherein the at least one first battery cell and the at least one second battery cell are battery cells of a traction battery pack.

12. The method of claim 1, wherein the at least one first battery cell and the at least one second battery cell are lithium-ion pouch cells.

13. A battery pack assembly, comprising:
at least one first battery cell each having first tab terminals extending from opposing sides of a first case;
at least one second battery cell each having a second tab terminals extending from opposing sides of a second case, the at least one first and second battery cells positioned adjacent to each other to provide a battery cell subassembly, the first and second tab terminals of the at least one first battery cell and the at least one second battery cell connected on a first side of the battery cell subassembly, the first and second tab terminals of the at least one first battery cell and the at least one second battery cell disconnected on an opposite, second side of the battery cell subassembly; and
a cross-member having at least one aperture, the first and second tab terminals that are disconnected inserted through the aperture.

14. The battery pack assembly of claim 13, wherein the cross-member is a first cross-member, and further comprising a second cross-member, the first and second tab terminals that are connected on the first side are sandwiched between the second cross-member and cases of the at least one first battery cell and the at least one second battery cell.

15. The battery pack assembly of claim 13, wherein the first and second battery cells are lithium-ion pouch cells.

16. The battery pack assembly of claim 13, wherein the first and second tab terminals that are connected on the first side are directly joined to each other with at least one weld.

17. The battery pack assembly of claim 13, wherein the first and second battery cells are constituents of a traction battery pack.

18. The battery pack assembly of claim 13, wherein at least one first battery cell and the at least one second battery cell of the battery cell subassembly are connected in series to each other.

19. The battery pack assembly of claim 13, wherein a voltage of the battery cell subassembly is below 60 Volts.
